(19) United States
(12) Patent Application Publication
(10) Pub. No.: US 2014/0380142 A1
(43) Pub. Date: Dec. 25, 2014

(54) CAPTURING WEBSITE CONTENT THROUGH CAPTURE SERVICES

(71) Applicant: Microsoft Corporation, Redmond, WA (US)

(72) Inventors: Ian William Mikutel, Redmond, WA (US); Jason Morrill, Redmond, WA (US); Eleazar Vega-Gonzalez, Bellevue, WA (US); Shikha Devesh Desai, Bellevue, WA (US); Yu Been Lee, Bellevue, WA (US); Scott Kurtzeborn, Redmond, WA (US); Yan Lu, Kirkland, WA (US)

(21) Appl. No.: 13/922,250

(22) Filed: Jun. 20, 2013

(51) Int. Cl. G06F 17/22

(52) U.S. Cl. CPC G06F 17/2247
USPC 715/234

(57) ABSTRACT

Website content curation can be performed through a capture service receiving a clipping of a web page rendered in a web browser. A clipping of at least a portion of the web page can be sent to multiple applications. The source of the clip can remain intact and be provided as part of the clipping. When a region of the web page is selected for a clip to one or more of multiple available applications, the clip can include an extended portion outside of a region specifically selected as the clip. A preview experience can be provided in which the clipping can be viewed and edited.

### BACKGROUND

When on a website, information may be copied or “clipped” into a note or clipboard. Clipping refers to the capturing of text, images or other content from a website for later access (e.g., reading, annotating, collecting) when not on the web site, and even off-line. A web clipper is a tool that generally runs on a web browser at a client to enable “clipping” of content from a web page displayed from the web browser. In this context, clipping refers to the extraction or capture of the hypertext markup language (HTML), text and/or graphic elements from a web page to facilitate the storage and curation.

A web clipper is usually associated with a specific destination application or storage, and is often provided by a developer of the destination application as a plug-in or add-on for a web browser so that a user can insert content from a web page easily into a document (e.g., a note or clipboard) associated with that destination application or storage.

### BRIEF SUMMARY

Techniques, systems and interfaces for capturing content from a web page are disclosed. Capture services are provided that enable clipping of content from a web page for curation and further processing.

In certain embodiments, content from a web page can be clipped to multiple destinations. For example, within a user interface of a clipping tool associated with a web browser, two or more destinations for a clipping are presented and can be selected to receive the clipping.

The capture service receives the clipping and an indication of the applications to send the clip to. In some cases, the capture service stores the clipping in a manner that the multiple applications can access and use.

In certain embodiments, a portion of a page can be clipped. For example, a region of a page can be selected for clipping or certain elements of the page can be extracted for clipping. According to various implementations, even when a portion of the page is clipped, the source clip can be kept intact.

In some embodiments, because the source (e.g., web page in a mark-up language) is kept intact with the clipping (as opposed to a screenshot), one method to provide a preview within a preview pane or window of a browser involves changing the size of a clip by scaling original mark-up language elements.

In addition, certain mark-up language elements (and in some cases other information) may be extracted and used locally by the clipping tool or at the capture service to provide additional features. In certain embodiments, the clipping tool sends additional portions of the page with the clipping to the capture service. The additional portions can be used to modify (and/or enhance) the clipping at the capture service and/or after the clip is sent to the destination application.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a system architecture diagram and process flow for an implementation.

FIG. 2 illustrates an example user interface for clipping to multiple destinations.

FIG. 3 illustrates a user interface for multiple application selection.

FIGS. 4A-4F illustrate scenarios involving a web clipper that may be implemented on a tablet device having a web browser client.

FIG. 5 illustrates a method of curating content through a capture service.

FIGS. 6A-6D illustrate an expanded capture scenario.

FIG. 7 illustrates an operating environment in which the website content curation may be practiced.

FIG. 8 is a block diagram illustrating components of a computing device used in some embodiments.

### DETAILED DESCRIPTION

Techniques, systems and interfaces for capturing content from a web page are disclosed. Capture services are provided that enable clipping of content from a web page for curation and further processing.

In certain embodiments, content from a web page can be clipped for multiple destinations, including sub-destinations. For example, within a user interface of a clipping tool (i.e., a web clipper) associated with a web browser, two or more destinations for a clipping of a web page are presented and can be selected to receive the clipping. The multiple destinations can include one or more applications such as a reader application (for collecting content—such as a reading list—for later viewing), a notebook application (such as MICROSOFT ONENOTE and EVERNOTE), a clip-boarding application (such as PINTEREST), a social media application (such as FACEBOOK and TWITTER), or a productivity application (such as MICROSOFT OFFICE, GOOGLE DOCS, and APPLE PAGES). Sub-destinations may include, as examples, a particular note section of a user's notebook application, a specific board of a clip-boarding application, or a particular document of a productivity application.

A web clipper is a tool that generally runs on a web browser at a client. Because each web browser has some different capabilities, web clippers may be configured based on the web browser. Some web page “clippers” capture information of a region of a screen within a selected box or frame. Other clippers capture an image of the viewing screen or even the entire page. Web clippers of various embodiments described herein can include one or more of these content capturing capabilities. According to certain implementations, the information captured by the web clipper can be a page, extracted portions of the page, and/or one or more regions of the page in response to a selection by a user.

The web clipper may run locally at the client device, facilitating the clipping of effectively anything rendered on a user's computer screen. The web clipper may be implemented in JavaScript, as an example, and can be interoperable (and in some cases integrated) with a web browser such as GOOGLE CHROME, APPLE SAFARI, MOZILLA FIREFOX, and MICROSOFT INTERNET EXPLORER. Certain implementations of the web clipper can be accessible as a bookmarklet. A bookmarklet is an extended functionality for a web browser, usually in the form of a JavaScript program stored as part of a bookmark in a web browser (or hyperlink on a web page).

Because the clipper runs locally in a browser, the clipper can capture any content currently shown in the browser display screen. Therefore, the clipper may capture content from sites that require a user to authenticate, such as FACEBOOK or a subscription newspaper service, which would not be accessible to the capture service directly. Once a user logs in to their account and content is rendered on their screen via the web browser, the clipper may capture the content.

Embodiments present a tool that can be used to clip, for example, an arbitrary region of a page, a text quote from a page, an image on a page, the entity represented by the page, the ‘main area’ of the page, a portion of the source for the page, or the entire source for the page. In some implementations, related pages may be captured. As an illustrative example, there may be an article available on a news site that is arranged on four pages. In a case where the clipper is applied while the user views one of the four pages, the clipper (for example, via the capture service) can capture the related pages. That is, a clipping of one of the four pages can also collect the other three pages of the article. In one embodiment, the clipper may clip multiple pages in scenarios where related content spans multiple web pages, for example where the HTML indicates paginated posts.

Various embodiments facilitate the clipping of content including, but not limited to, text, links, images, a whole web page including HTML and cascading style sheets (CSS), and part(s) of a web page, for storing in association with one or more of multiple available applications for creating, collecting, and curating content (such as a notebook application, word processing application, or other productivity, curation, or collaboration application).

A user currently expects a clipper to clip content and insert the content into a note or other application to which the clipper is associated. In many cases, the note or other application permits a user to access the content across many devices. Embodiments of the subject clipper not only clip content to one note or application to which the clipper is associated, but through a capture service associated with the clipper, can send the clip to other notes and/or applications. Then, when a user launches the other application, the content is available within that other application.

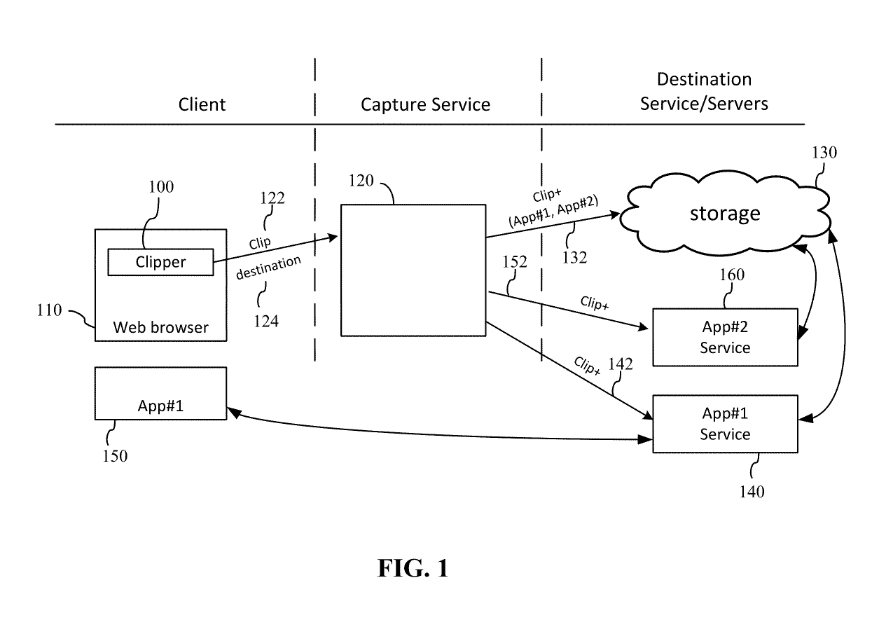

FIG. 1 illustrates a system architecture diagram and process flow for an implementation. At a client, a clipper 100 is used to clip and store content from a web page while a user is browsing the Web. The clipper 100 may be a plug-in, add-on, or bookmarklet to a web browser 110 running on the client.

A capture service 120 of an embodiment enables a clipping to be consumed by multiple applications and/or services. The capture service 120 receives the clip 122 and an indication of the destination(s) 124 for the clip. The clipper 100, via the capture service 120, can send the clipping to multiple applications (not just a single application).

The clipper 100 provides the tool to select one or more of multiple applications available to receive the clipping. The capture service 120 receives the clip 122 and an indication of the application(s) (e.g., App#1, App#2) to which the clipping will be sent (e.g., destination 124), and, in a further embodiment, performs some processing to customize or augment the clipping for an application (creating the “clip+”). A user can select to clip the whole page, extracted portions of the whole page, and/or one or more regions of the page.

In some cases, the clipper can send the HTML to the capture service and the capture service may fetch the images on the page instead of the clipper at the client sending the images. This feature may be useful for scenarios where a client is functioning on a limited bandwidth (or a user wants to minimize the bandwidth usage), such as the case with certain mobile devices.

A preview experience of the clip can be provided by the capture service to the client and/or the clipper running on the client may render the preview. The preview can be rendered in a preview pane or window in the browser, or be rendered in place in the browser. The preview pane (or other preview experience) can be part of a clipping user interface in which editing, tagging, and other actions may be accomplished.

For cases where the preview is rendered by the client, the client may scale a version of the original page using either an image or the original HTML/CSS. For cases where the preview is generated by the capture service, the service may pass back an image or HTML/CSS to the client to render.

In some cases, the capture service stores the clipping in a manner that the multiple applications can access and use.

In some cases, the capture service stores the clip from the user, and any application that would like access to the clip may request the clip from the service. In some cases, the capture service actively sends the clip to the selected destinations' storage solutions.

The clipper may in some implementations, only send the URL or pointer reference to the assets used to capture the web page (e.g., source, images, CSS files, or other content). Then, the capture service may download those assets (e.g., source, images, CSS files, and the like) using the URLs from the clipper. Alternatively, the clipper may capture the assets in full at the client and then send the assets to the service for storing.

For example, the clipper (directly or via the capture service 120) can make a networking call to a service (e.g., cloud storage 130) that stores the data for a corresponding one or more applications that the user selects to receive the clip.

The call (with request 132) can include the clip (and any augmentation or additional features available through the clipper and/or capture service) and destination specific information (that may be used by the particular applications accessing the clip). Then, when a user accesses the clipping through one of the applications, that application can later connect to the database storing the data for the application and get the updates.

For example, a clipping to App#1 140 can be carried out by a direct communication 142 from the capture service 120 to the service for App#1 140 (which may then store the clip) or by storing the clip at the storage 130 from which the App#1 service (140) can access. Then, when a user accesses the App#1, such as via a native viewer 150 at the client or via the web browser 110, the clipping will be available to the user.

In one contemplated scenario, a user at the client may be browsing the Web using a web browser 110 and desires to share or save content being viewed in the web browser 110. A clipper 100 can communicate with the web browser 110 to capture the source of a web page rendered by the web browser 110. When a user clips content from the web page using the clipper 100, the clip 122 (including source code) and destination selections 124 are sent to a capture service 120. The capture service can perform some processes with respect to the clip as well as communicate with storage services 130 and/or other application services (e.g., 140, 160) to enable the clip to be inserted into an application document.

In an example scenario, a user can save an article or blog that the user is reading online by “clipping” the content to save and read later. By using the clipper, which communicates with the capture service, the user can send the clipping automatically to a reading application, for example, the capture service 120 can send the clip 152 directly to App#2 160. In addition, the capture service may remove advertisements and make it easier to read or include certain tags or augmentations to facilitate the retrieval of the content from a particular application.

To clip content for multiple destinations (e.g., destination files of multiple applications such as App#1 and App#2 of the example illustrated in FIG. 1), a user can perform a single clipping. Then, in the background (i.e., in a manner not shown to a user), the clipper sends the clip for the multiple destinations. The clipper can send the content to selected applications without launching those applications. In some cases, an option can be presented to the user to launch an application through the clipper.

When multiple destinations are indicated for receipt of a clip, the clip that is saved to the multiple destinations may be different for each destination. That is, the resulting clip that is sent to each application does not have to be the same. For example, one destination (e.g., App#1) may receive the clip in the form of text and images, and another destination (e.g., App#2) may receive the clip in the form of a full HTML version that can maintain text formatting, CSS styling, layout of the page, and the like.

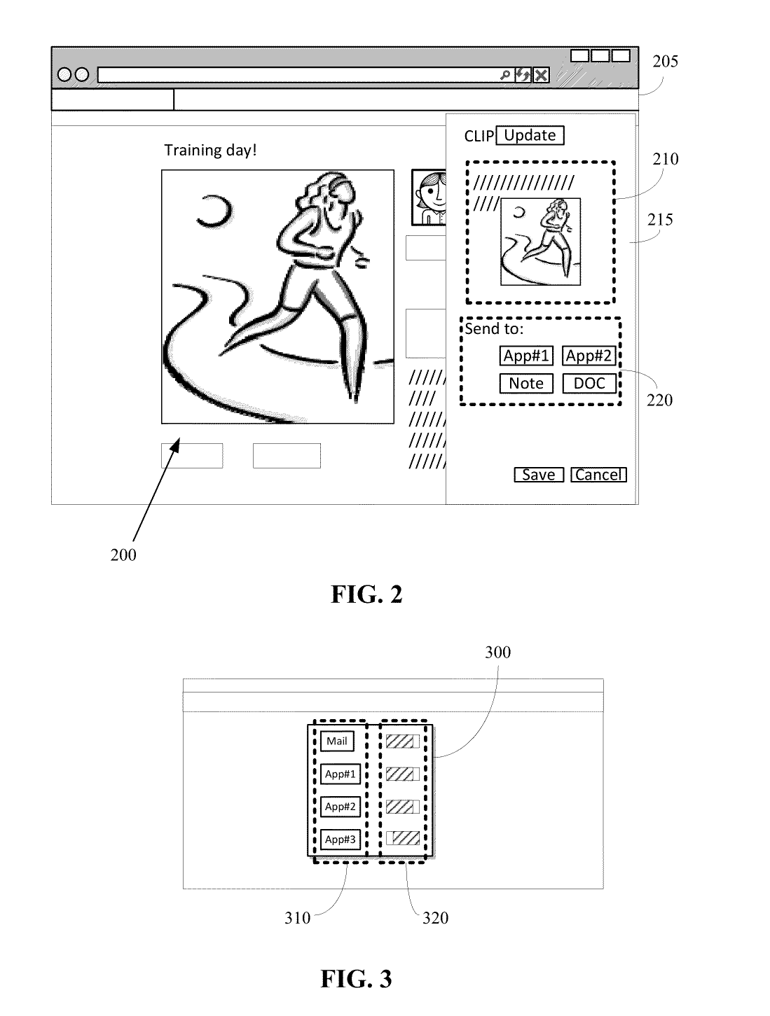

It should be noted that FIGS. 2, 4A-4F, and 6A-6D illustrate a number of screen shots associated with aspects of the subject disclosure as provided with respect to a computing device. Such screen shots are merely exemplary and provided to graphically depict at least one embodiment of aspects of the disclosure. Of course, the subject disclosure is not intended to be limited to the location or presentation of graphical elements provided since there are a myriad of other ways to achieve the same or similar result, some of which are shown in one or more of the screen shots.

FIG. 2 illustrates an example user interface for clipping to multiple destinations. Referring to FIG. 2, a web page 200 rendered in a web browser 205 can be clipped using a clipper in accordance with an implementation of the invention. A preview 210 of the clip can be rendered in a preview pane 215 of the clipper. One or more of multiple destinations 220 can be selected by a user to send the clip. In some implementations, the destinations may be pre-selected (where a user may change the selection) before the clip is saved. In some other implementations, the destinations may be automatically selected for the user and saved.

The clip can be sent to various applications, such as reader application or a social media application (e.g., FACEBOOK), a notebook application (such as ONENOTE), and even, in some cases, a document hosted by a cloud storage service (or productivity application such as MICROSOFT WORD and MICROSOFT OFFICE Web App) or stored locally at the client.

In addition to selecting destinations for the clip, the clipper can present editing functionality within the preview pane 215. According to certain implementations, the selected clip can be automatically saved upon selection. From the preview pane, a user may edit the clip, for example, by adding metadata or tags. In some implementations, annotations may be added via key board, mouse, pen, or other input device (including finger). Since an initial save occurs upon selection (and preview) of a clip, a second save may be carried out as an update save when a user modifies or edits the clip within the preview pane. That is, the clipper enables a user to update the metadata or any of the metadata associated with the clip after the first save. In some cases, this can reduce the number of clips sent to a destination because modifications can be carried out to update a same clipping. In some scenarios, separate regions on a page can be selected in consecutive clips, where the clips may be displayed in a same preview. In one such implementation, multiple clips may be selected before a first save.

FIG. 3 illustrates a user interface for multiple application selection. Destinations available from the clipper can be set by the user. For example, as shown in FIG. 3, a user can select the application(s) to which the clipper will be able to send clips. The setting selection interface 300 may be available as part of a settings menu, the preview pane, or some other accessible window.

Applications that the capture service is aware of can be presented to the user and the user can control whether those destinations are viewable on the clipper by selecting application(s) 310 via, for example, a switch 320, dropdown menu (not shown), or checkbox (not shown) indicator.

In many cases a log in setup may be available so that the clipper has the user's username for the application, which may be used to help store the clip or send the clip to an appropriate account of an application.

In certain implementations, the setting selection interface 300 can be dynamically updated (by the capture service or another service associated with the clipper) with available applications for the user to include as destinations. In some implementations, a user may be able to add applications that may not be presented by the clipper settings interface by inputting certain information such as a URL or other destination address accessible over the Internet for the clipper to save or send the clip to. This may also be a way to include a shortcut on the clipper preview to clip to a file locally on the client.

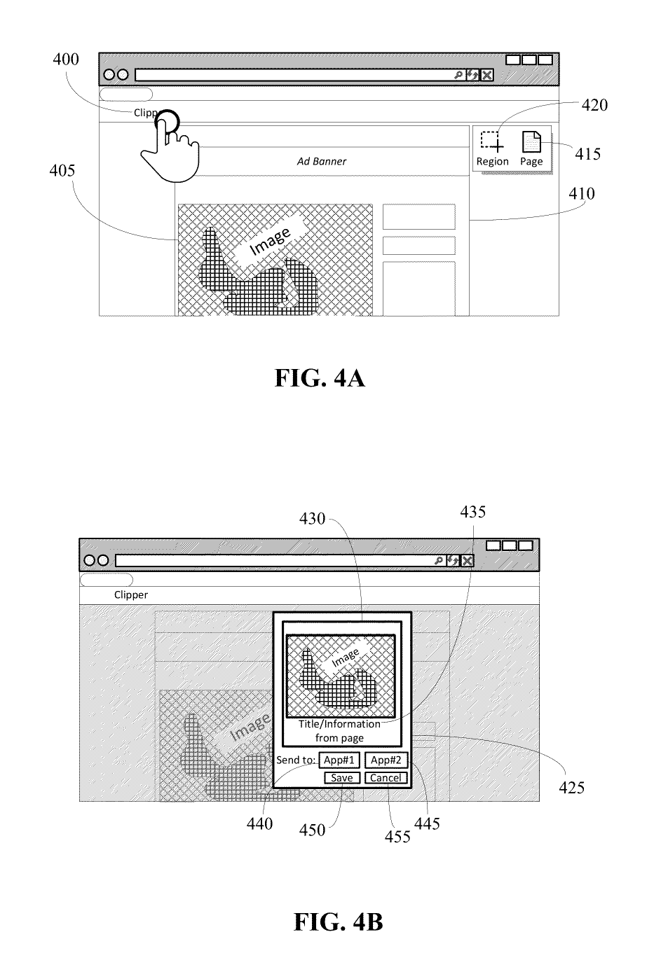

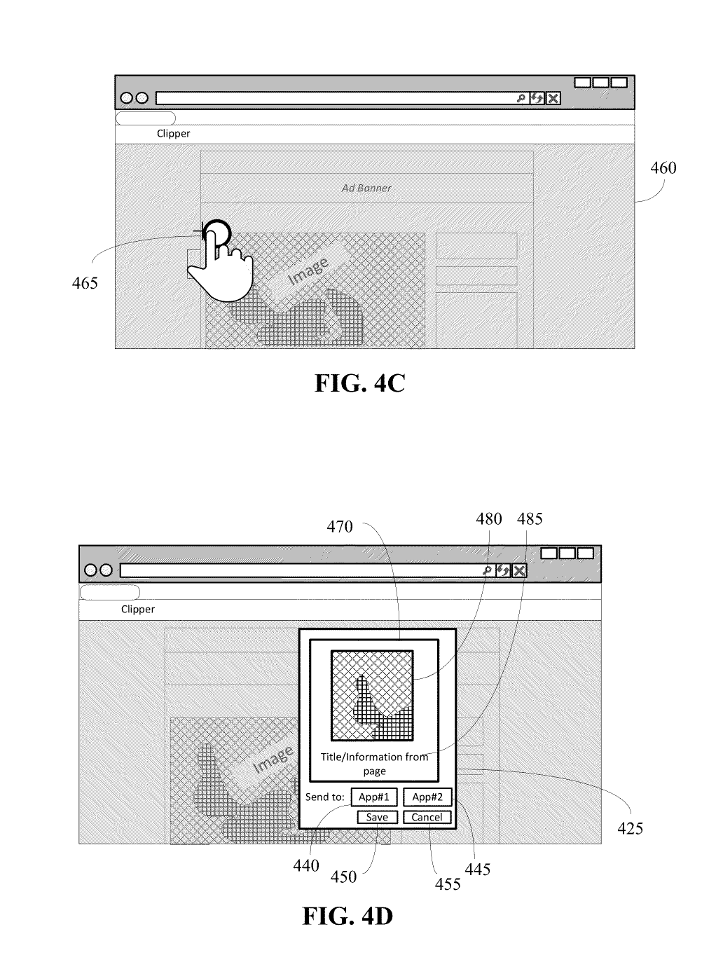

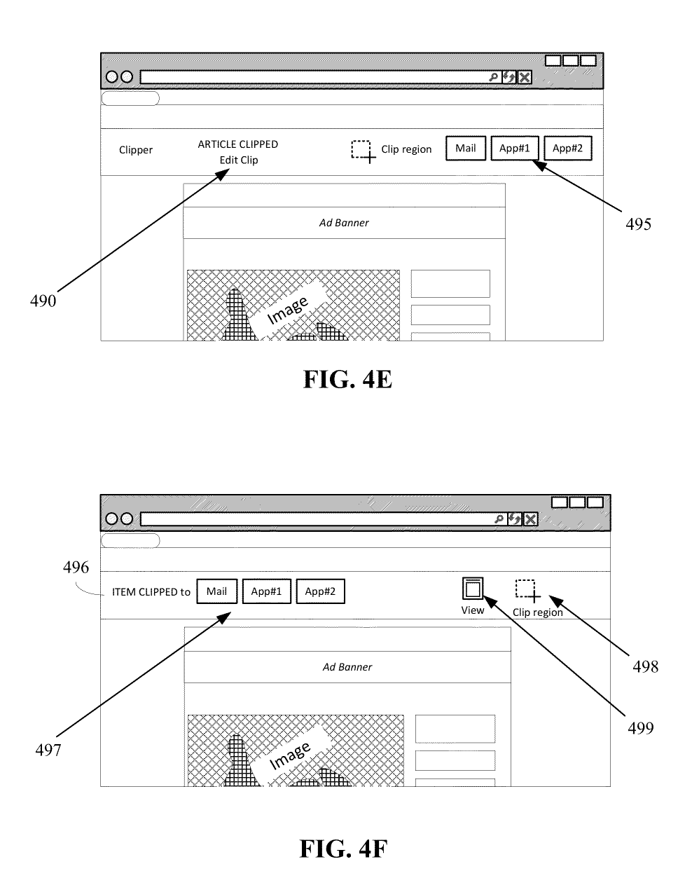

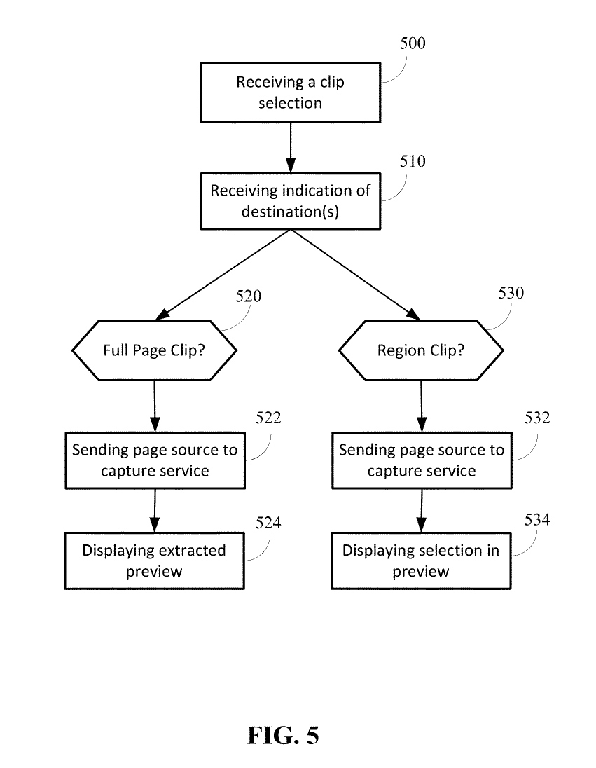

FIGS. 4A-4E illustrate scenarios involving a web clipper that may be implemented on a tablet device having a web browser client; and FIG. 5 illustrates a process flow according to an implementation.

Clippings can be carried out in a number of ways. In one case, an entire page can be clipped. According to an implementation, the original source code can be clipped. In other cases, portions of a page can be clipped.

Referring to FIG. 4A, a user can select to clip (via a clipper 400) content 405 from a web page 410. The selection may be performed, for example, by clicking on the command using a mouse or other input device, touching the command (or using another gesture), or by voice selection. The clipper may enable a page selection (415) and/or region selection (420).

Referring to FIG. 5, the clipper can receive a clip selection (500) from a clipper (e.g., clipper 400 of FIG. 4A). The clipper can also receive an indication of the destination(s) to which the clip will be sent (510). FIGS. 4B, 4D, and 4E illustrate example user interfaces in which a user can select destination(s) for the clip.

The clip selection can be a selection to clip a page (520) (such as page selection 415 of FIG. 4A). In some cases, the clip selection may be a selection to clip a region (530) (such as region selection 420 of FIG. 4A).

If the clipping is of a page (520), the page source can be sent to the capture service (522) and the full page or an extracted portion of the page can be displayed in a preview (524).

As shown in FIG. 4B, for a page selection (415) clip, the clipper can open a window 425 (or preview pane) so that the user may preview and edit a clip 430 without opening the application(s) to which the clip 430 is being sent. Information and other data 435 from the web page may be displayed in the preview window 425. In some implementations, a clip may be edited while in the preview pane/window/experience by application of annotations. The application of annotations can include typing, drawing, or writing on the clip displayed in the preview. The annotations may be stored with the clipping on save.

In some cases, a document object model (DOM) of the web page can be captured and saved as a clip and sent to an application (e.g., one or more destinations). The DOM includes the HTML and CSS web page (and in some cases may include extensible markup language (XML), Stylesheet, Traversal, Ranges, Events or specific event sets). A DOM provides a standardized interface and objects for accessing and manipulating information stored in HTML and XML documents.

In some cases, additional pages that are linked or otherwise related to the page being clipped can be captured. The capturing of related pages may be similar to capturing additional information from a page beyond a region specifically selected by a user.

The clipper preview window 425 can include options for the user to send the clip to multiple applications, such as App#1 440 and App#2 445. From the window 425, a user may save 450 or cancel 455 a clip (or edits to a clip) of the contents.

If the clipper is in region selection mode (530), a selection tool (represented, for example, as cross-hairs) may be presented to the user.

As shown in FIG. 4C, for a region selection (420) clip, a user can select a region for clipping while the clipper is in a region select mode 460, which may be indicated, for example, by a change in color of the web page or other visual indicator. In one scenario, the region selection can be done by clicking and dragging a clipping tool to select the portion of the page for clipping. In another scenario, the region selection (420) can be done by a touch 465 and swipe (or other gesture). As another scenario, region selection can be performed upon a user clicking or touching a portion of the page and the clipper automatically captures a logical portion of the page based on the portion clicked or touched by the user. As yet another scenario, a user may use a pen, stylus, lasso tool, or finger to circle/highlight (or “ink”) a portion of the page to perform a freeform selection.

The region selected by the user can be captured by the clipper, including the source code for the region. In a further embodiment, the source code for the regions surrounding the selection can also be captured as an extended region. In some cases, the full source of the page may be captured.

When a user selects the portion of the page in a region mode, for example via a freeform and/or rectangular selection, the HTML elements that fall within the selected region are clipped. In various embodiments, the source (e.g., the HTML) is kept intact as part of the clip.

The user can make a free-form or rectangular selection; and the capture includes the underlying HTML—in addition to or in place of an image capture of the displayed web page. As shown in FIG. 4D, a preview 470 of the clipped portion 480 (and optionally information 485 from the page 410) can be displayed in the preview window 425 of the clipper user interface.

For various implementations including those described herein, the window (e.g., preview window 425) may be a separate window or a preview surfaced on the page. For example, the box selection of a region may remain on the page after selection so that a user can confirm the capture directly on the box selection.

Returning to FIG. 5, the region, extended region, and/or the full page source may be sent to the capture service (532) and the selected region displayed in the preview (534). The clip can be provided to the capture service to store the clip for the user (e.g., for one or more of multiple available applications).

FIG. 4E illustrates another example of clipper menu bar. In the interface shown in FIG. 4E, a region clipping is available to edit 490 a clip that was saved (for example as performed with respect to FIG. 4B or FIGS. 4C and 4D. In addition, a selection or addition of a destination 495 can be made.

FIG. 4F shows another screen shot of a clipper menu bar 496, which may be rendered after saving a clip such as clip 430. As shown in FIG. 4F, the destinations 497 to which the clip is saved can be shown in the clipper menu bar 496. For example, a user may have selected in a preview pane (or in a clipper menu bar) the destinations 497 of mail, App#1 and App#2, and the clipper menu bar 496 can display these destinations 497. From the clipper menu bar 496, a user may edit the clip, for example, by changing or adding to the page clip 430 with a region clip 498. In addition, a preview pane, such as window 425, can be accessed from the clipper menu bar via the view selection 499. The preview pane may include additional editing functionality and features. Editing functionality from the preview pane can include tagging, annotating, and other features.

Although the figures show two types of clipping features, it should be understood that more or fewer than two types may be available for a clipper. In some implementations, only one of the two types (page or region) may be available. In some implementations other types of clipping can be carried out in place of or in addition to the page and/or region clipping. For example, the clipper may include selection and/or extraction capabilities based on recognized features or preset or user input parameters, or a combination thereof. As another example, browser state may be used by the clipper to determine that the currently selected text is to be captured when the clipper is invoked.

In some implementations, instead of a freeform and/or rectangular capture, elements can be captured from a page based on type or other distinguishing feature. For example, a user may be able to capture the images of a web page by indicating an image selection (and the system selects the images on the web page after determining the images available on the web page). As another example, a clipping may be obtained of the elements on the web page that are located in quotes.

The service can take the whole page (or source), extract the portions selected by the user, and save the relevant sections.

In some implementations, the capture service looks at the structure of a web page so that the components can be parsed and the desired elements captured. For example, because images (and even video) are structured elements of a web page, the capture service can recognize and capture images (and video). In one implementation, images from a slideshow embedded on a webpage may be extracted and saved for a user.

As illustrated in some of the example scenarios, HTML can be captured using an interaction model. Not only are HTML tags captured from within the selected region, but additional tags can be captured to maintain the integrity of the region that is selected by the user. In this manner, the HTML tags captured with the user selection may go outside the clip selection that the user clipped.

The extra HTML tags can be used to enable expansion of a selection after-the-fact while that content is in the notebook application (or other application to which the content is sent). That is, a destination application for a clipping may re-use or repurpose a clipping because of the source HTML/tags provided along with the clip.

The clipping is more than a converted object because the source remains intact and saved as part of the clip. For example, because HTML is captured as part of the clipping, the user can, for example, click and highlight the text and copy it, resize the page, and perform other editing features. Similarly, the use of HTML in the preview pane facilitates resizing using the HTML tags.

In the example shown in FIGS. 4C-4D, a region selection (via touch selection 465) of only part of the image is selected (as reflected by the preview image of clipped portion 480 in the preview window 425). According to an embodiment, a larger portion or the entire image and any element that is visible within the selection being clipped can be obtained. Each element can be copied in its entirety even when only partially visible within the selection. The positioning of each element relative to each other can stay the same.

In one embodiment, a region that a user selects can be clipped and, along with the portion that is clipped, an extended portion can be captured. The extended portion can be extra content from around the region designated by the user for clipping. In some cases, the content from around the region is content displayed (or encoded) within a distance from the selection. In other cases, the content from around the region is the entire page, a significant portion of the page, or content determined to be relevant to the selected portion.

By providing additional HTML than what is selected, further functionality can be implemented at the application receiving the clipping. This additional HTML may be considered an expansion region. The expansion region may provide context for the clipping or be used to enable additional features after the clip is saved.

For example, a peek or expand feature may be available on “hover” over the image of the clipping in the destination application (and in some cases the preview pane) because of the additional HTML provided with the clipping. Then, a user can click and expand the image to show the rest of the image (or a larger portion) even though at the time the user clipped the portion of the page, the user may not have been aware that the expanded content was also included.

Whether a full page capture or a region capture, a clipping viewed in a preview or at a destination file may include a representation of the web page based on the title of the page, a main image on the page (also referred to as a hero image) and a description. This representation may be referred to as a snippet. Snippets are based on content extracted from the HTML or other markup language provided by the page, and refer to a short text and/or image preview that can be displayed, for example, when representing the web page in a search result list.

HTML involves a set of markup tags (and plain text) that describe document content, including web pages. Some of this content may be available from metatags defined using the Open Graph protocol. The description of the content in HTML (or other markup language) can be referred to as the source or source code of the page. The source of a web page includes rendered information such as rendered text, images, and video; and hidden information, such as metadata and styles.

In some embodiments, because the source (e.g., HTML) is clipped along with an image of the web page within the selection, one method to provide a preview within a preview pane involves changing the size of a clip by scaling original HTML elements. A scaling parameter is an element in the HTML for a web page. The scaling parameter is generally used as part of the CSS and web technologies to facilitate the rendering of a web page on different sized screens and view windows. According to an embodiment, the portion(s) of the web page selected by the clipper are saved to a file and previewed in a preview pane (or window). When rendering the HTML to preview the clip in the preview pane or window, the clipper sets the scaling parameter to a value suitable to fit the clip within the preview pane or window.

Certain embodiments set a default value for the scale property to transform the captured web page to a scale suitable for the preview pane. Certain embodiments perform calculations to determine a value for the scale property in order to scale the selection by the amount necessary to fit in to a preview user interface. The preview renders the selection to small dimensions by scaling the HTML instead of keeping original dimensions or taking a screenshot and/or generating a smaller image to represent the user selection region.

For example, when a user makes a selection that is bigger than the available space for preview, the clipper can set the scaling parameter of the HTML to make the selected region displayed smaller onscreen (in a preview pane or on a separate device having a smaller screen than that used to originally capture the web content), but while still preserving its original structure.

According to various implementations, even when a portion of the web page is clipped, more than the “clipped” portion can be sent to the capture service. In some cases, the full page is sent. For example, when a user selects a portion of the web page or when an automated selection of recognized content is made, the full page may be saved in the background for the user (along with the source code). In some cases less than the full page is sent. For example, HTML tags surrounding a selected region (as a portion of the page) may also be sent as part of the clipping available to the application, but not necessarily shown to the user.

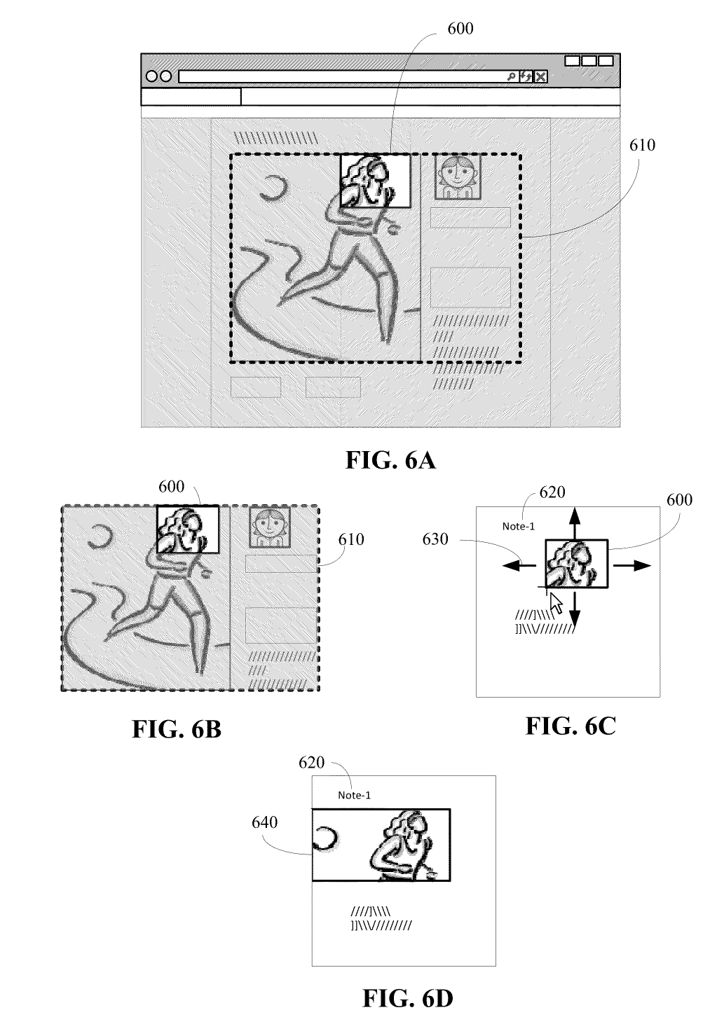

By sending more than actively clipped by the user, content may be expanded without having to return to the web page to perform another clipping because the clipper sent the whole page (or at least more than what was specifically shown to the user as clipped) at the time of the capture. An example scenario is illustrated in FIGS. 6A-6D.

FIG. 6A shows a representation of a region clip where a user selects a region 600 of a web page for clipping and the clipper captures the source for the selected region 600 along with an expanded region 610. The expanded region may be based on distance from the edges of the selection, bounded by a recognized feature (such as an end of a paragraph or edge of an image), or a combination of distance and recognizable features. In some embodiments, the full page is provided even when a region is selected for clipping. As part of the clip, the clipper sends the selected region and expanded region to a destination application.

The destination application receives the clip, including the selected region 600 and expanded region 610 as shown in FIG. 6B. However, when a user opens a note 620, such as “note-1” or other destination receiving the clip (or even, in some cases, when viewing the selection in the preview pane), the user sees the selected region while the extended region is hidden from the user as shown in FIG. 6C. Thus, a region clip (e.g. from the selected region 600) as shown in FIG. 6C includes (hidden from the user in the note 620) tags and content from the expanded region. Because of the additional content, a user may edit and adjust the clip while within the note 620, for example, by expanding the image. In some implementations, a graphical indicator, such as an arrow 630, may be presented to a user to indicate that expansion is available. By using the additional information provided along with the region clip, a user can adjust the content displayed as part of the clip (creating an adjusted view 640 in the note 620) as shown in FIG. 6D.

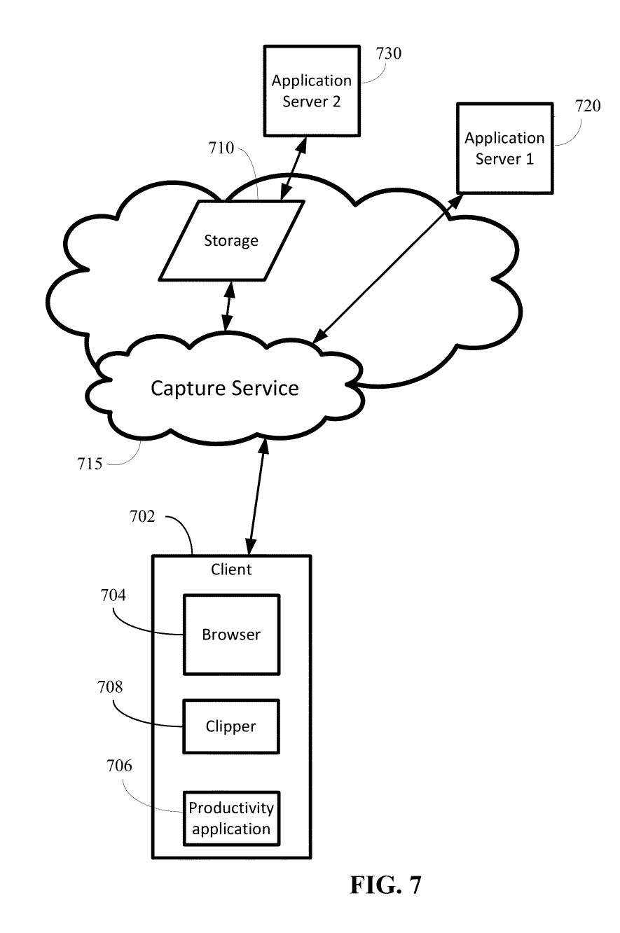

FIG. 7 illustrates an operating environment in which the website content curation may be practiced. As illustrated in FIG. 7, an operating environment for a user may include one or more clients 702. The client(s) may be embodied as a computing device such as a desktop, laptop, smartphone, tablet, reader, game console, smart television and the like.

The client(s) 702 can involve computing systems configured with one or more central processing units (CPUs), memory, mass storage, and I/O devices (e.g., network interface, user input device). Elements of a computing system can communicate with each other via a bus.

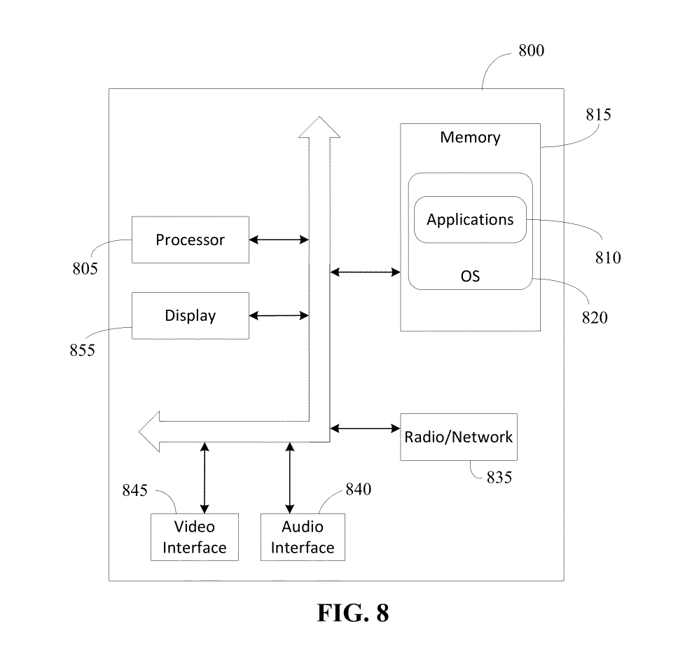

FIG. 8 shows a block diagram illustrating components of a computing device used in some embodiments. For example, system 800 can be used in implementing a computing device embodying the client(s) 702. It should be understood that aspects of the system described herein are applicable to both mobile and traditional desktop computers, as well as server computers and other computer systems.

For example, system 800 includes a processor 805 that processes data according to instructions of one or more application programs 810, and/or operating system (OS) 820. The processor 805 may be, or is included in, a system-on-chip (SoC) along with one or more other components such as network connectivity components, sensors, video display components.

The one or more application programs 810 may be loaded into memory 815 and run on or in association with the operating system 820. Examples of application programs include phone dialer programs, e-mail programs, information management programs, word processing programs, Internet browser programs, messaging programs, game programs, notebook applications and the like. Other applications may be loaded into memory 815 and run on the device, including various client and server applications.

Examples of operating systems include SYMBIAN OS from Symbian Ltd., WINDOWS PHONE OS from Microsoft Corporation, WINDOWS from Microsoft Corporation, BLACKBERRY OS from Research In Motion Limited, IOS from Apple Inc., and ANDROID OS from Google Inc. Other operating systems are contemplated.

System 800 may also include a radio/network interface 835 that performs the function of transmitting and receiving radio frequency communications. The radio/network interface 835 facilitates wireless connectivity between system 800 and the “outside world,” via a communications carrier or service provider. Transmissions to and from the radio/network interface 835 are conducted under control of the operating system 820, which disseminates communications received by the radio/network interface 835 to application programs 810 and vice versa.

The radio/network interface 835 allows system 800 to communicate with other computing devices, including server computing devices and other client devices, over a network.

In various implementations, data/information stored via the system 800 may include data caches stored locally on the device or the data may be stored on any number of storage media that may be accessed by the device via the radio/network interface 835 or via a wired connection between the device and a separate computing device associated with the device, for example, a server computer in a distributed computing network, such as the Internet. As should be appreciated such data/information may be accessed through the device via the radio interface 835 or a distributed computing network. Similarly, such data/information may be readily transferred between computing devices for storage and use according to well-known data/information transfer and storage means, including electronic mail and collaborative data/information sharing systems.

An audio interface 840 can be used to provide audible signals to and receive audible signals from the user. For example, the audio interface 840 can be coupled to a speaker to provide audible output and to a microphone to receive audible input, such as to facilitate a telephone conversation. System 800 may further include video interface 845 that enables an operation of an optional camera (not shown) to record still images, video stream, and the like. The video interface may also be used to capture certain images for input to a natural user interface (NUI).

Visual output can be provided via a display 855. The display 855 may present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form.

The display 855 may be a touchscreen display. A touchscreen (which may be associated with or form part of the display) is an input device configured to detect the presence and location of a touch. The touchscreen may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some embodiments, the touchscreen is incorporated on top of a display as a transparent layer to enable a user to use one or more touches to interact with objects or other information presented on the display.

In other embodiments, a touch pad may be incorporated on a surface of the computing device that does not include the display. For example, the computing device may have a touchscreen incorporated on top of the display and a touch pad on a surface opposite the display.

Returning to FIG. 7, client(s) 702 can be used to browse the Web and run applications such as a browser 704 and, in some cases, a productivity, reader or notebook application 706. A user interface for applications such as the browser 704 may be in HTML, Objective C, Java, or other language depending on the platform. A clipper 708 can be included as an add-on or plug-in for the browser 704.

Web content can be sent to a user's note or other application document through the clipper 708. The note or other application document may be stored in the cloud (e.g., as storage 710). In some cases, a local copy of the note or other application is available. The note or other application document may be accessed or associated with the application 706 running on the client. The clipper 708 can provide content from the browser 704 to multiple notes and/or other application documents, as well as present additional functionality and enhancements through a capture service 715.

The capture service 715 can be web service that may be hosted in the cloud or run by one or more allocated servers by an entity providing the notebook service or the capture service.

A cloud service generally refers to hosted services providing scalable processing and storage capabilities. Cloud computing may often include virtualized resources. The resources presented by cloud computing are in themselves provided as a service, where cloud computing customers rent usage of resources from a third-party provider that owns the physical infrastructure. Web services can be provided and/or hosted by a cloud service (e.g., as part of a large-scale distributed computing environment). A web service is a software system that supports interoperable machine-to-machine interaction over a network and enables software to connect to other software applications.

A web service provides a collection of technological standards and protocols. For example, a web service provides functions that may be implemented by a software or hardware agent that sends and receives messages (e.g., the computing platforms requesting and providing a particular service). Applications can access web services via ubiquitous web protocols and data formats such as hypertext transfer protocol (HTTP), XML, JavaScript Object Notation (JSON), and SOAP (originally an acronym for simple object access protocol).

The capture service 715 may be implemented using one or more physical and/or virtual servers communicating over a network. In some cases, the capture service 715 may store or maintain an address of the clippings provided from the clipper 708 in the storage 710. The clippings can be accessed by multiple applications, directly from a storage 710 or through the capture service 715, for inserting into different types of documents. For example, a first application server 720 can communicate with the capture service 715 to receive the clipping. Alternatively, an application, such as available through the second application server 730, can access the storage to which the clipping is saved and, due to the clipping being in a form understandable by the application of the second application server, recognizes the clipping to be associated with files of the type used by the application.

The various networks described and/or shown as part of the environment illustrated in FIG. 7 can include, but are not limited to, an internet, an intranet, or an extranet, and can be any suitable communications network including, but not limited to, a cellular (e.g., wireless phone) network, the Internet, a local area network (LAN), a wide area network (WAN), a WiFi network, an ad hoc network or a combination thereof. Such networks may involve connections of network elements, such as hubs, bridges, routers, switches, servers, and gateways. The network may include one or more connected networks (e.g., a multi-network environment) including public networks, such as the Internet, and/or private networks such as a secure enterprise private network. Access to the network may be provided via one or more wired or wireless access networks as will be understood by those skilled in the art.

Certain techniques set forth herein may be described in the general context of computer-executable instructions, such as program modules, executed by one or more computing devices. Generally, program modules include routines, programs, objects, components, and data structures that perform particular tasks or implement particular abstract data types.

Embodiments may be implemented as a computer process, a computing system, or as an article of manufacture, such as a computer program product or computer-readable medium. Certain methods and processes described herein can be embodied as code and/or data, which may be stored on one or more computer-readable media. Certain embodiments of the invention contemplate the use of a machine in the form of a computer system within which a set of instructions, when executed, can cause the system to perform any one or more of the methodologies discussed above. Certain computer program products may be one or more computer-readable storage media readable by a computer system and encoding a computer program of instructions for executing a computer process.

Computer-readable media can be any available computer-readable storage media or communication media that can be accessed by the computer system.

Communication media include the media by which a communication signal containing, for example, computer-readable instructions, data structures, program modules, or other data, is transmitted from one system to another system. The communication media can include guided transmission media, such as cables and wires (e.g., fiber optic, coaxial, and the like), and wireless (unguided transmission) media, such as acoustic, electromagnetic, RF, microwave and infrared, that can propagate energy waves. Carrier waves and other propagating signals that may contain data usable by a computer system are not themselves “computer-readable storage media.”

By way of example, and not limitation, computer-readable storage media may include volatile and non-volatile, removable and non-removable media implemented in any method or technology for storage of information such as computer-readable instructions, data structures, program modules or other data. For example, a computer-readable storage medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); or other media now known or later developed that is capable of storing computer-readable information/data for use by a computer system. “Computer-readable storage media” do not consist of carrier waves or propagating signals.

In addition, the methods and processes described herein can be implemented in hardware modules. For example, the hardware modules can include, but are not limited to, application-specific integrated circuit (ASIC) chips, field programmable gate arrays (FPGAs), and other programmable logic devices now known or later developed. When the hardware modules are activated, the hardware modules perform the methods and processes included within the hardware modules.

Example scenarios have been presented to provide a greater understanding of certain embodiments of the present invention and of its many advantages. The example scenarios described herein are simply meant to be illustrative of some of the applications and variants for embodiments of the invention. They are, of course, not to be considered in any way limitative of the invention.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

It should be understood that the examples and embodiments described herein are for illustrative purposes only and that various modifications or changes in light thereof will be suggested to persons skilled in the art and are to be included within the spirit and purview of this application.

What is claimed is:

1. A method of capturing content through a capture service, comprising:
receiving a clip selection of a web page rendered in a browser; and
sending the clip selection to be saved for a selected one or more applications of a plurality of applications available for receipt of the clip selection.

2. The method of claim 1, wherein receiving the clip selection comprises receiving an indication for capturing a page of content,
wherein sending the clip selection to be saved for the selected one or more applications comprises sending an intact source of the page, the method further comprising:
displaying a preview of an extracted selection of the page of content.

3. The method of claim 1, further comprising automatically sending one or more additional web pages related to the clip selection.

4. The method of claim 1, wherein receiving the clip selection comprises receiving an indication of a freeform selection of a region of content.

5. The method of claim 1, wherein receiving the clip selection comprises receiving an indication of a rectangular selection of a region of content.

6. The method of claim 1, wherein the clip selection comprises markup language corresponding to a selected region and an extended region in addition to the selected region.

7. The method of claim 1, further comprising generating a preview of the clip selection by setting a scaling parameter in a markup language of the clip; and
displaying the preview of the clip selection.

8. The method of claim 1, further comprising receiving an edit of the clip selection after sending the clip selection to be saved for the selected one or more applications; and
sending an update for the clip selection to be saved for the selected one or more applications, wherein the update comprises the edit of the clip selection.

9. An interface for capturing content from a web page, comprising:
a preview display region configured to display a preview of a clip selection comprising a selected region of a web page by rendering markup language of the selected region and assigning a scaling parameter of the markup language of the selected region for a size of the preview display region; and
a destination input field configured to display multiple available destination applications and receive a selection of one or more of the multiple available destination applications for receipt of a clip selection.

10. The interface of claim 9, further comprising an edit input field for initiating an update to the clip selection.

11. The interface of claim 9, wherein the clip selection further comprises an extended region in addition to the selected region.

12. The interface of claim 9, wherein the selected region is a page of the web page.

13. The interface of claim 9, wherein in response to determining the selection of one or more of the multiple available destination applications, the interface sends the clip selection to be saved for the one or more of the available destination applications.

14. A computer-readable storage medium having instructions stored thereon that cause a processor to perform a method for capturing content of a web page comprising:
capturing a source of a clip selection in response to receiving an indication of a clip selection of a web page rendered in a browser;
sending the clip selection to be saved for a selected one or more applications of a plurality of applications available for receipt of the clip selection; and
displaying a preview of the clip selection.

15. The medium of claim 14, wherein receiving the indication of the clip selection comprises:
receiving a selection of a region of a web page.

16. The medium of claim 15, wherein capturing the source of the clip selection comprises capturing the source of the region and an extended portion in addition to the region.

17. The medium of claim 16 wherein displaying the clip selection comprises displaying the region while the extended portion is hidden.

18. The medium of claim 14, wherein the source comprises at least one hypertext markup language (HTML) tag.

19. The medium of claim 14, wherein displaying the clip selection comprises rendering markup language of the clip selection and assigning a scaling parameter of the markup language of the selected region for a size of a preview display region.

20. The medium of claim 14, wherein sending the clip selection to be saved for the selected one or more applications comprises sending an intact source of a page.
